(19) United States
(12) Patent Application Publication
(10) Pub. No.: US 2019/0172608 A1
(43) Pub. Date: Jun. 6, 2019

(54) CONDUCTIVE WIRE AND COVERED CONDUCTIVE WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Takeshi SHIMIZU, Yokkaichi-shi (JP); Masaharu SUETANI, Yokkaichi-shi (JP); Daisuke HASHIMOTO, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/088,215

(22) PCT Filed: Mar. 28, 2017
(86) PCT No.: PCT/JP2017/012633

§ 371 Date: Sep. 25, 2018

(30) Foreign Application Priority Data
Apr. 15, 2016 (JP) 2016-081769

(51) Int. Cl. H01B 7/04; H01B 5/12

(52) U.S. Cl. CPC H01B 7/04; H01B 5/12

(57) ABSTRACT

A conductive wire that includes a plurality of conductors that are obtained by braiding metal wires, wherein the plurality of conductors are bundled into one elongated shape, the plurality of conductors are each tubular, and the plurality of conductors are merged together concentrically. In addition, a covered conductive wire includes the conductive wire and a covering that covers the conductive wire.

This application is the U.S. National Phase of PCT/JP2017/012633 filed Mar. 28, 2017, which claims priority from JP 2016-081769 filed Apr. 15, 2016, the entire disclosure of which is incorporated herein by reference.

### BACKGROUND

The present disclosure relates to a conductive wire, and particularly relates to a conductive wire suitable for a high current to flow therethrough.

JP 2015-103457A discloses an example in which an electric wire has a core wire made of a single conductive wire, and an example in which the core wire is made of a plurality of bare wires that are merged together to a twisted wire.

### SUMMARY

Meanwhile, when a high current is caused to flow through an electric wire, the electric wire is preferably thick so that heat generation is prevented, for example. However, a thick electric wire is hard, and thus is difficult to bend.

Even if a twisted wire is used as the core wire, a plurality of bare wires are twisted tightly. Accordingly, there may be cases where sufficient bendability cannot be achieved.

An exemplary aspect of the disclosure makes a conductive wire easy to bend.

A conductive wire according to a first aspect includes: a plurality of conductors that are obtained by braiding metal wires, wherein the plurality of conductors are bundled into one elongated shape.

A second aspect relates to the conductive wire according to the first aspect wherein the plurality of conductors are braided wires in which the metal wires are braided into a tubular shape.

A third aspect relates to the conductive wire according to the first or second aspect, wherein the plurality of conductors are each tubular, and the plurality of conductors are merged together concentrically.

A fourth aspect relates to the conductive wire according to the third aspect, wherein the conductive wire is provided with, at least partially in a direction in which the conductive wire extends, an increased diameter portion in which the conductors are expanded to have a large diameter.

A fifth aspect relates to the conductive wire according to the first or second aspect, wherein the plurality of conductors include a central conductor arranged in the center and a plurality of surrounding conductors arranged around the central conductor.

A sixth aspect relates to the conductive wire according to the fifth aspect, wherein the conductive wire is provided with, at least partially in a direction in which the conductive wire extends, a twisted portion in which the plurality of conductors are twisted.

A seventh aspect relates to the conductive wire according to the first or second aspect, wherein the plurality of conductors are stacked on each other.

An eighth aspect relates to the conductive wire according to the seventh aspect, wherein the conductive wire is provided with, at least partially in a direction in which the conductive wire extends, a twisted portion in which the plurality of conductors are twisted.

A covered conductive wire according to a ninth aspect includes the conductive wire according to any one of the first to eighth aspects; and a covering that covers the conductive wire.

A tenth aspect relates to the covered conductive wire according to the ninth aspect, wherein the covering is obtained by subjecting a heat shrinkable tube that is covering the conductive wire to thermal shrinkage.

### Advantageous Effects of Disclosure

According to the first aspect, since a plurality of conductors that are obtained by braiding metal wires are included, and the plurality of conductors are bundled into one elongated shape, the conductive wire is easy to bend.

According to the second aspect, since the conductors are braided wires, the conductive wire is easier to bend.

According to the third aspect, the merged state of the plurality of conductors is likely to be kept.

According to the fourth aspect, the conductive wire is easy to bend at the increased diameter portion.

According to the fifth aspect, since the central conductor is surrounded by the plurality of surrounding conductors, the conductive wire is easy to bend.

According to the sixth aspect, the conductive wire is easy to bend at the twisted portion. Furthermore, the plurality of conductors are less likely to separate from each other.

According to the seventh aspect, it is easy to manufacture the conductive wire.

If, as in the eighth aspect, a plurality of conductors are stacked on each other, the conductive wire is easy to bend in its stacking direction. Accordingly, if the conductive wire at least partially is provided with a twisted portion, then the stacking direction in which the plurality of conductors are stacked is rotated around the axis of the conductive wire. This makes the conductive wire easy to bend in various directions. Furthermore, the plurality of conductors are less likely to separate from each other.

According to the ninth aspect, it is possible to easily use the covered conductive wire as a wiring path.

According to the tenth aspect, it is possible to easily cover the conductive wire.

### BRIEF DESCRIPTION OF THE DRAWINGS

FIG. 1 is a schematic plan view illustrating a conductive wire according to a first embodiment.

FIG. 2 is a partially enlarged view of FIG. 1.

FIG. 3 is a schematic cross-sectional view taken along a line III-III in FIG. 1.

FIG. 4 is a schematic cross-sectional view taken along a line IV-IV in FIG. 1.

FIG. 5 is a schematic plan view illustrating a covered conductive wire.

FIG. 6 is a diagram illustrating a process for manufacturing a covered conductive wire according to a first modification.

FIG. 7 is a schematic plan view illustrating the covered conductive wire according to the first modification.

FIG. 8 is a schematic plan view illustrating a conductive wire according to a second modification.

FIG. 9 is a schematic cross-sectional view taken along a line IX-IX in FIG. 8.

FIG. 10 is a schematic plan view illustrating a conductive wire according to a second embodiment.

FIG. 11 is a schematic cross-sectional view taken along a line XI-XI in FIG. 10.

FIG. 12 is a schematic plan view illustrating a conductive wire according to a third embodiment.

FIG. 13 is a schematic cross-sectional view taken along a line XIII-XIII in FIG. 12.

FIG. 14 is a cross-sectional view taken along a line XIV-XIV in FIG. 12.

### DETAILED DESCRIPTION OF EMBODIMENTS

### First Embodiment

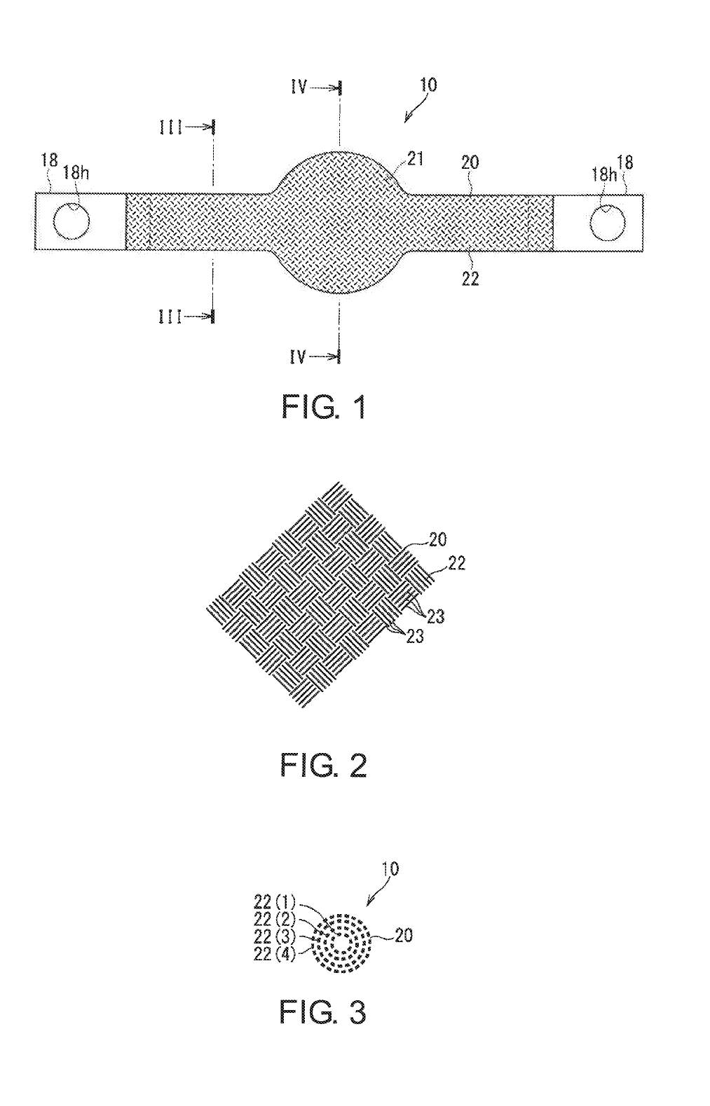

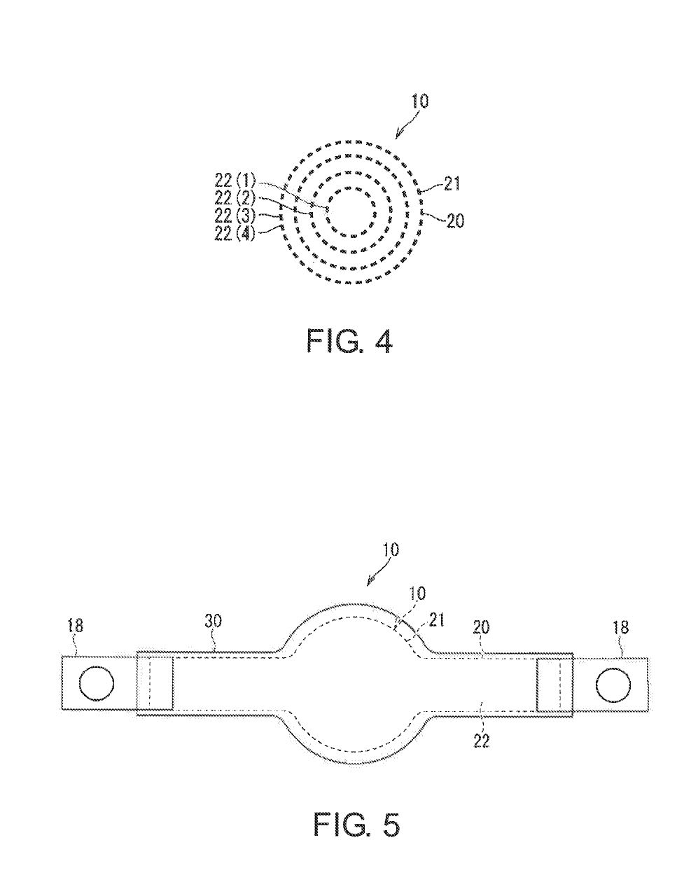

Hereinafter, a conductive wire and a covered conductive wire according to a first embodiment will be described. FIG. 1 is a schematic plan view illustrating a conductive wire 20, FIG. 2 is a partially enlarged view of FIG. 1, FIG. 3 is a schematic cross-sectional view taken along a line III-III in FIG. 1, and FIG. 4 is a schematic cross-sectional view taken along a line IV-IV in FIG. 1.

The conductive wire 20 is installed in vehicles and the like, and is used as an electrically conductive path through which a current flows. Particularly, in vehicles and the like, the conductive wire 20 can be used as a power supply wire connected to a motor, a power generator, a battery or the like, and is used as an electrically conductive path suitable for a high current to flow therethrough.

The conductive wire 20 includes a plurality of conductive members 22, and has a configuration in which the plurality of conductive members 22 are bundled into one elongated shape.

The plurality of elongated conductive members 22 are merged at ends of the conductive wire 20, and terminals 18 are connected thereto. The terminals 18 are made of a metal plate such as copper or a copper alloy, and are used to connect the conductive wire 20 to other apparatuses or the like. Here, the terminals 18 each have a hole 18h. With the holes 18h, bolting or the like is performed to realize mechanical fixation and electrical connection between the terminals 18 and terminals or the like of other apparatuses. The connection between the ends of the conductive wire 20 and the terminals 18 is made using ultrasonic bonding, resistance welding, soldering, crimping connection, or the like.

Each elongated conductive member 22 has an elongated shape made by braiding metal wires 23. The metal wires 23 may be wires made of copper, a copper alloy, aluminum, an aluminum alloy or the like, or wires obtained by plating the metal wires with tin or the like. If aluminum or an aluminum alloy is used as the metal wires 23, a lightweight conductive wire 20 and a lightweight covered conductive wire 10 can be obtained. Here, the elongated conductive member 22 is a braided wire in which the plurality of metal wires 23 are braided into a tubular shape. More specifically, the elongated conductive member 22 is formed in such a manner that the plurality of metal wires 23 or a plurality of bundles of metal wires 23, which are each obtained by bundling a plurality of metal wires 23, are arranged so as to draw spirals in different directions, and are braided so that the metal wires 23 or the bundles of metal wires 23 that draw spirals in different directions are located alternately on the inner circumferential side and the outer circumferential side (see FIG. 2). Such an elongated conductive member 22 is relatively flexible since it is braided so that the plurality of metal wires 23 intersect with each other in longitudinal and lateral directions. Moreover, it is also possible to increase the diameter of the elongated conductive member 22 by enlarging the space between the metal wires 23. Note that it is sufficient that the conductive wire 20 is elongated in a state in which a plurality of conductive members are bundled together, and thus it is not essential that the individual conductive members are elongated.

Also, the plurality of (here, four) elongated conductive members 22 are bundled together so that they are merged together concentrically. Hereinafter, when individual elongated conductive members 22 are distinguished, the reference numerals 22(1), 22(2), 22(3), and 22(4) are given to them in order from the inner circumferential side, and when individual elongated conductive members 22 do not need to be distinguished, the reference numeral 22 is given to them. That is, the elongated conductive member 22(1) arranged closest to the center is surrounded on its outer circumference by another elongated conductive member 22(2), which is surrounded on its outer circumference by another elongated conductive member 22(3), which is surrounded on its outer circumference by yet another elongated conductive member 22(4). Thus, the plurality of elongated conductive members 22(1), 22(2), 22(3), and 22(4) are bundled together so that the plurality of elongated conductive members 22(1), 22(2), 22(3), and 22(4) are arranged concentrically.

Note that any number of elongated conductive members 22 may be bundled together, and the number may also be two or three, or five or more. Furthermore, since it is possible to increase the diameters of the elongated conductive members 22 made of braided wires by changing the pitch of the spirals of the metal wires 23 or enlarging the mesh, it is possible to manufacture elongated conductive members 22 originally having the same size. Of course, it is also possible to manufacture a plurality of elongated conductive members 22 in which the size of the conductive members increases toward the outer circumferential side.

Furthermore, the conductive wire 20 is provided with, at least partially in a direction in which it extends (extension direction), an increased diameter portion 21. The increased diameter portion 21 is formed to have an increased diameter by expanding the braided wires. In the increased diameter portion 21, the conductive wire 20 made of braided wires is expanded so that its diameter is increased relative to the remaining part of the conductive wire 20. In the increased diameter portion 21, the metal wires 23 are loosened toward the outer circumferential side. Accordingly, if the conductive wire 20 is bent at the increased diameter portion 21, the loosened metal wires 23 on the outer side of the bent position can be gently bent, and the metal wires 23 on the inner side of the bent position can be bent at a sharper angle. Accordingly, it is easy to bend the conductive wire 20 at the increased diameter portion 21.

The increased diameter portion 21 as described above can be formed by compressing the conductive wire 20 along its extension direction. More specifically, the increased diameter portion 21 can be formed by compressing the conductive wire 20, before the increased diameter portion 21 is formed, on two sides in the extension direction of the conductive wire 20.

FIG. 5 is a schematic plan view illustrating the covered conductive wire 10 provided with the conductive wire 20 and a covering 30.

The covering 30 is an insulating member that covers the conductive wire 20. The covering 30 can be formed, for example, such that the conductive wire 20 is covered with a heat shrinkable tube and the heat shrinkable tube in this state is subjected to thermal shrinkage. Accordingly, it is possible to easily cover the conductive wire 20 with the covering 30. Of course, the covering 30 may also be a resin extruded to cover the conductive wire 20, a resin obtained by performing metal molding using the conductive wire 20 as an insert, or the like.

According to the conductive wire 20 and the covered conductive wire 10 that are configured in the above-described manner, the conductive wire 20 has a configuration in which a plurality of elongated conductive members 22 obtained by braiding the metal wires 23 are bundled into one elongated shape. The plurality of elongated conductive members 22 obtained by braiding the metal wires 23 are easier to bend than a conductive wire made of a single metal wire. The elongated conductive members 22 are also easier to bend than a conductive wire in which a plurality of metal wires are tightly twisted, because the metal wires of the plurality of elongated conductive members 22 are dispersed. Accordingly, the conductive wire 20 and the covered conductive wire 10 are easy to bend.

Moreover, the plurality of elongated conductive members 22 obtained by braiding the metal wires 23 have a large surface area, and thus are superior in heat dissipation properties and are suitable for use as an electrically conductive path through which a high current flows.

Furthermore, the braided wire is woven so that the metal wires 23 are tubular, and thus are easy to bend. Moreover, the braided wire is unlikely to widen compared to a metal mesh, a metal cloth, and the like, and thus it is easy to realize a thin conductive wire 20.

Furthermore, a general-purpose braided wire for sealing may also be used as the braided wire. This also contributes to a cost reduction. Furthermore, depending on the magnitude of a current that is supposed to flow, it is also possible to change the number of elongated conductive members 22, so that it is easy to accommodate various situations.

Furthermore, since the plurality of elongated conductive members 22 made of braided wires are bundled together concentrically, the plurality of elongated conductive members 22 are less likely to separate from each other and are likely to remain merged together. Particularly, if the elongated conductive members 22 are circular in the cross section orthogonal to the extension direction, the elongated conductive members 22 are easy to bend in directions intersecting with the extension direction.

Moreover, since the conductive wire 20 is provided with the increased diameter portion 21, the conductive wire 20 is particularly easy to bend at the increased diameter portion 21.

Also, since the conductive wire 20 is provided with the covering 30, it is possible to use it alone as a covered conductive wire 10 in wiring path, without adding any other insulation measure.

The following will describe modifications of the first embodiment.

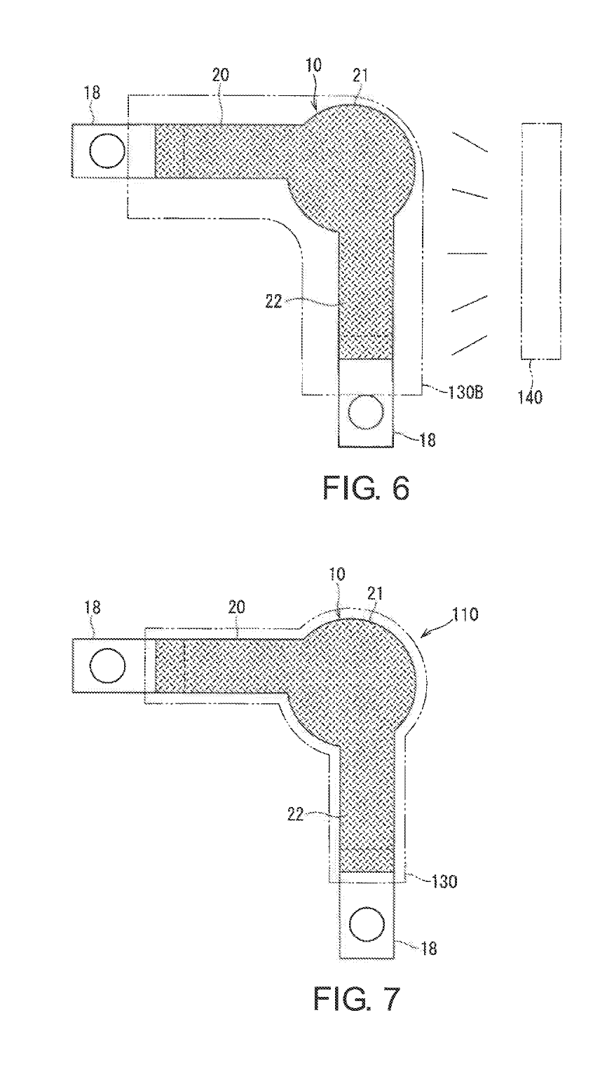

FIG. 6 is a diagram illustrating the process for manufacturing a covered conductive wire 110 according to a first modification, and FIG. 7 is a schematic plan view illustrating the covered conductive wire 110 according to the first modification.

That is, in the first modification, as shown in FIG. 6, the conductive wire 20 that is bent at the increased diameter portion 21 is covered with a heat shrinkable tube 130B. In this state, the heat shrinkable tube 130B is heated using a heating device 140 such as a heater, is subjected to thermal shrinkage, and is deformed to the shape conforming to the outer circumference of the conductive wire 20, resulting in a covering 130. Note that the heat shrinkable tube 130B may also be provided with, on the inner circumferential surface thereof, a hot-melt adhesive layer.

According to the first modification, the heat shrinkable tube 130B thermally shrinks to the shape conforming to the bent shape of the increased diameter portion 21, and serves as the covering 130. Accordingly, the covered conductive wire 110 is manufactured in the shape in which it is bent at the increased diameter portion 21. Accordingly, the covered conductive wire 110 can be easily arranged along a largely curved path.

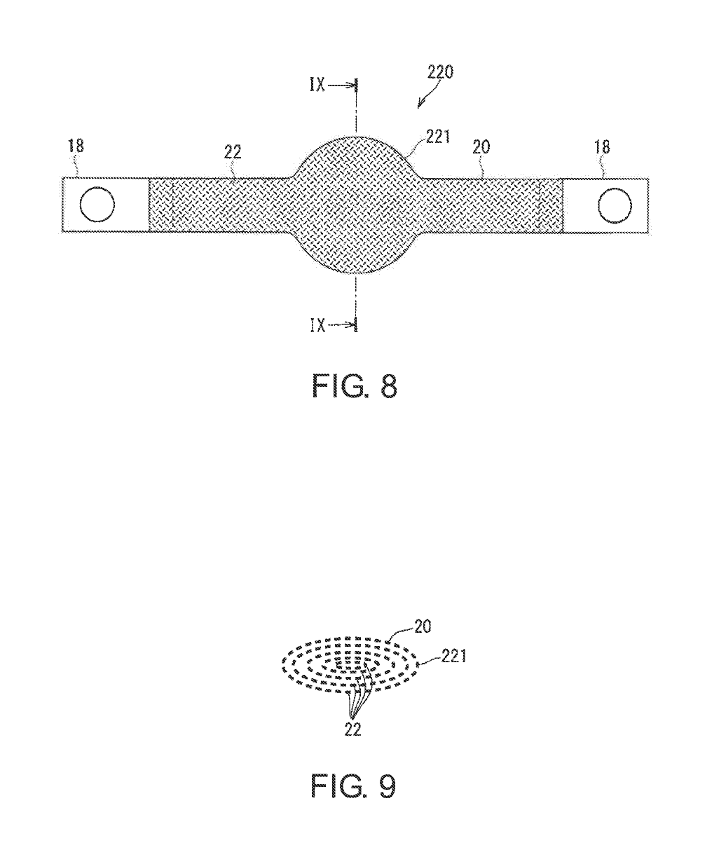

FIG. 8 is a schematic plan view illustrating a conductive wire 220 according to a second modification, and FIG. 9 is a schematic cross-sectional view taken along a line IX-IX in FIG. 8.

The conductive wire 220 has an increased diameter portion 221 that is obtained by compressing the increased diameter portion 21 of the conductive wire 20 in one direction orthogonal to the extension direction of the conductive wire 20. In other words, in the increased diameter portion 221, the elongated conductive members 22 made of braided wires have a flattened tubular shape, and are arranged concentrically with the flattened portions aligned. If the increased diameter portion 221 is bent in its thickness direction, there is a small difference in length of the path between the inner side and the outer side of the bent shape. Accordingly, the increased diameter portion 221 can easily be bent in its thickness direction.

### Second Embodiment

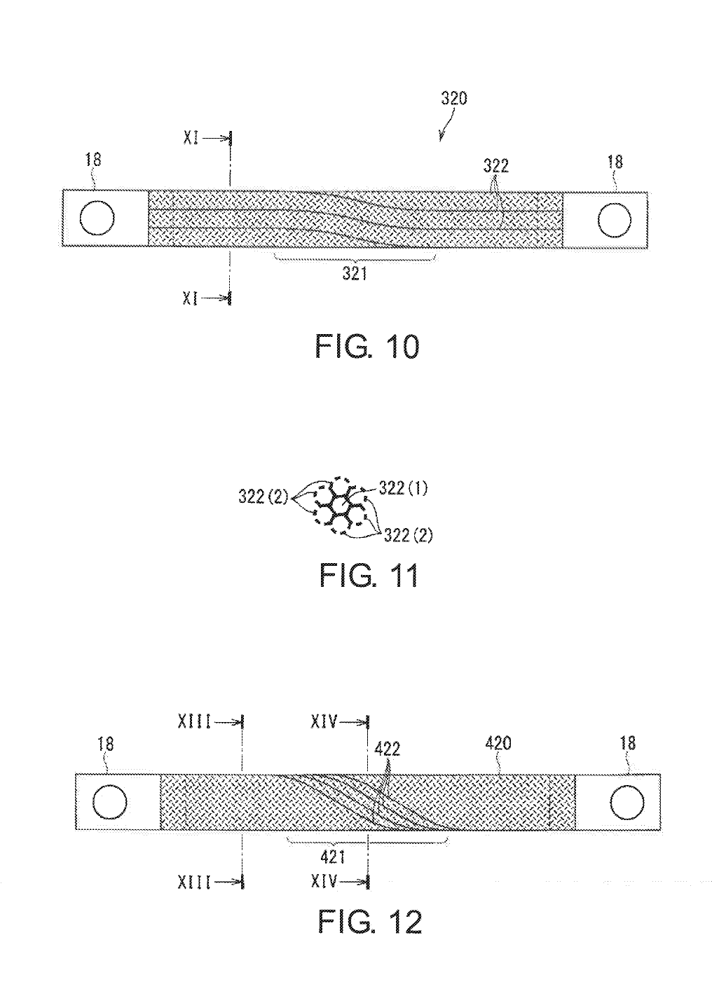

Hereinafter, a conductive wire according to a second embodiment will be described. FIG. 10 is a schematic plan view illustrating a conductive wire 320, and FIG. 11 is a schematic cross-sectional view taken along a line XI-XI in FIG. 10.

The conductive wire 320 has a configuration in which a plurality of elongated conductive members 322 are bundled into one elongated shape.

As in the first embodiment, terminals 18 are connected to ends of the conductive wire 320.

The elongated conductive members 322 are similar to the elongated conductive members 22. Here, the elongated conductive members 322 are each a braided wire in which a plurality of metal wires 23 are braided into a tubular shape.

The plurality of elongated conductive members 322 include a central elongated conductive member 322(1) arranged in the center, and a plurality of surrounding elongated conductive members 322(2) arranged around the central elongated conductive member 322(1). Hereinafter, when the elongated conductive members are distinguished between the central elongated conductive member and the surrounding elongated conductive members, the reference numerals 322(1) and 322(2) are used to distinguish them, and when such a distinction is not made, the reference numeral 322 is given to them.

Here, one central elongated conductive member 322(1) is surrounded by six surrounding elongated conductive members 322(2). Any number of surrounding elongated conductive members 322(2) may be used, and the number may also be two to five, or seven or more. Furthermore, another elongated conductive member may further be arranged on the outer circumference of the six surrounding elongated conductive members 322(2) that surrounds the one central elongated conductive member 322(1). The arrangement of the central elongated conductive member 322(1) and the plurality of surrounding elongated conductive members 322(2) is maintained by joining, at ends of the conductive wire 320, ends of the central elongated conductive member 322(1) to ends of the plurality of surrounding elongated conductive members 322(2) using ultrasonic bonding, resistance welding, soldering, crimping fixation, or the like.

Each elongated conductive member 322 is preferably a braided wire whose diameter is so small that it alone can remain tubular, but this is not essential.

Furthermore, the conductive wire 320 is provided with, at least partially in its extension direction, a twisted portion 321, in which the plurality of elongated conductive members 322 are twisted. Here, the twisted portion 321 is formed in an intermediate portion, in the extension direction, of the conductive wire 320. Here, the twisted portion 321 is twisted by 180 degrees, but may also be twisted by an angle greater than 180 degrees, for example, by one turn or more.

According to the conductive wire 320, it is possible to achieve the same functions and effects as those of the foregoing first embodiment, except for the effect obtained by bundling together the elongated conductive members 22 concentrically.

Furthermore, since the central elongated conductive member 322(1) is surrounded by the plurality of surrounding elongated conductive members 322(2), the central elongated conductive member 322(1) and the surrounding elongated conductive members 322(2) are individually easy to bend, and moreover the central elongated conductive member 322(1) and the surrounding elongated conductive members 322(2) are displaced with respect to each other in their extension direction and thus are easy to bend. Accordingly, it is possible to make the conductive wire 320 as a whole easy to bend.

Furthermore, the central elongated conductive member 322(1) and the surrounding elongated conductive members 322(2) are easily bundled together to have a circular cross section.

Furthermore, in the twisted portion 321, since the plurality of elongated conductive members 322 are twisted, the surrounding elongated conductive members 322(2) each draw a spiral path. Accordingly, when the individual surrounding elongated conductive members 322(2) are bent, they are likely to stretch and deform. Also in this regard, the conductive wire 320 is easy to bend.

Furthermore, in the twisted portion 321, the plurality of elongated conductive members 322 are less likely to separate from each other.

### Third Embodiment

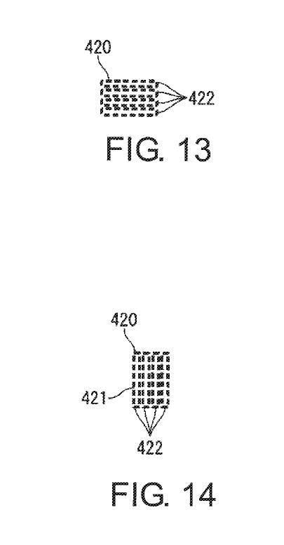

Hereinafter, a conductive wire according to a third embodiment will be described. FIG. 12 is a schematic plan view illustrating a conductive wire 420, FIG. 13 is a schematic cross-sectional view taken along a line XIII-XIII in FIG. 12, and FIG. 14 is a cross-sectional view taken along a line XIV-XIV in FIG. 12.

The conductive wire 420 has a configuration in which a plurality of elongated conductive members 422 are bundled together into one elongated shape.

As in the first embodiment, terminals 18 are connected to ends of the conductive wire 420.

The elongated conductive members 422 are similar to the elongated conductive members 22. Here, the elongated conductive members 422 are each a braided wire in which a plurality of metal wires 23 are braided into a tubular shape.

The conductive wire 420 is obtained by stacking the plurality of elongated conductive members 422. Here, since the elongated conductive members 422 are made of braided wires, the braided wires are flattened, and are stacked on one another in their thickness direction. Here, four elongated conductive members 422 are stacked on one another, but any number of elongated conductive members 422 may be stacked on one another, and the number may also be two, three, or five or more. It is also possible that, as a result of a large number of elongated conductive members 422 being stacked on one another, the thickness, in the stacking direction, of the conductive wire 420 is greater than its width. The arrangement of the plurality of elongated conductive members 422 is maintained by joining, at ends of the conductive wire 420, ends of the plurality of elongated conductive members 422 to each other using ultrasonic bonding, resistance welding, soldering, crimping fixation, or the like.

Furthermore, the conductive wire 420 is provided with, at least partially in its extension direction, a twisted portion 421, in which the plurality of elongated conductive members 422 are twisted. Here, the twisted portion 421 is formed in an intermediate portion, in the extension direction, of the conductive wire 420. Here, the twisted portion 421 is twisted by 180 degrees, but may also be twisted by an angle greater than 180 degrees, for example, by one turn or more.

According to the conductive wire 420, it is possible to achieve the same functions and effects as those of the foregoing first embodiment, except for the effect obtained by bundling together the elongated conductive members 22 concentrically.

Furthermore, the conductive wire 420 can be manufactured easily, since the plurality of elongated conductive members 422 only need to be stacked on one another.

Furthermore, since the plurality of elongated conductive members 422 are stacked on one another, the elongated conductive members 422 are individually easy to bend, and moreover the elongated conductive members 422 are displaced with respect to each other in their extension direction and thus are easy to bend. Accordingly, it is possible to make the conductive wire 420 as a whole easy to bend, specifically, in the thickness direction of the elongated conductive members 422.

Furthermore, in the twisted portion 421, since the plurality of elongated conductive members 422 are twisted, the direction in which the plurality of elongated conductive members 422 are stacked on one another is rotated around the axis of the conductive wire 420. Accordingly, the conductive wire 420 is easy to bend in various directions.

Furthermore, in the twisted portion, the plurality of elongated conductive members 422 are less likely to separate from each other.

### Modification

In the above-described embodiments, the descriptions have been given taking an example in which a plurality of elongated conductive members obtained by braiding metal wires are braided wires, but this is not necessarily required. For example, in the first embodiment and the second embodiment, metal meshes or metal cloths in each of which metal wires are woven into a sheet and the side edges, on both ends, thereof are joined to each other into a tubular shape, for example may be used as the elongated conductive members. Furthermore, in the second embodiment or the third embodiment, components in which metal wires are woven into a sheet and are formed as a band may be used as the elongated conductive members.

Note that the configurations described in the foregoing embodiments and the modifications may be combined with each other as appropriately as long as they are not inconsistency with respect to each other. For example, in the second embodiment and the third embodiment, the conductive wire may also be covered circumferentially with a heat shrinkable tube or the like.

The present disclosure has been described in detail, but the description above is exemplary in all respects, and the present disclosure is not limited to those. It is to be understood that a number of modifications that are not exemplified are possible without departing from the scope of the present disclosure.

1-2. (canceled)

3. A conductive wire comprising:
a plurality of conductors that are obtained by braiding metal wires,
wherein the plurality of conductors are bundled into one elongated shape,
the plurality of conductors are each tubular, and
the plurality of conductors are merged together concentrically.

4. The conductive wire according to claim 3,
wherein the conductive wire is provided with, at least partially in a direction in which the conductive wire extends, an increased diameter portion in which the conductors are expanded to have a large diameter.

5. The conductive wire according to claim 3,
wherein the plurality of conductors are braided wires in which the metal wires are braided into a tubular shape.

6-8. (canceled)

9. A covered conductive wire comprising:
the conductive wire according to claim 3; and
a covering that covers the conductive wire.

10. The covered conductive wire according to claim 9,
wherein the covering is obtained by subjecting a heat shrinkable tube that is covering the conductive wire to thermal shrinkage.
